(19) United States
(12) Patent Application Publication
(10) Pub. No.: US 2014/0207391 A1
(43) Pub. Date: Jul. 24, 2014

(54) Torque socket structure

(71) Applicant: Wei-Ning HSIEH, Taichung City (TW)

(72) Inventor: Wei-Ning HSIEH, Taichung City (TW)

(21) Appl. No.: 13/745,902

(22) Filed: Jan. 21, 2013

(51) Int. Cl. G01L 5/00

(52) U.S. Cl. CPC G01L 5/0042
USPC 702/43

(57) ABSTRACT

A torque socket structure contains a body including a connecting hole for connecting with a torque wrench and a driving orifice for driving nuts or screws, wherein the driving orifice communicates with the connecting hole, the body includes a stepped difference formed between the connecting hole and the driving orifice, and a thickness between the body and the connecting hole is greater than a thickness between the body and the driving orifice; a digital detecting mechanism including a torsion strain gage fixed on a predetermined section of the outer wall of the body which corresponds to the driving orifice, a processing unit electrically connecting with the torsion strain gage so as to receive and calculate torque value detected by the torsion strain gage, a display unit electrically connecting with the processing unit so as to display torque value calculated by the processing unit.

### FIELD OF THE INVENTION

The present invention relates to a torque socket structure which has highly accurate sensing function, and its torque socket is capable of measuring a torque data forced on a working end of the torque socket structure accurately, sensitively, and linearly.

### BACKGROUND OF THE INVENTION

A conventional digital adaptor for a torque tool disclosed in TW filing no. 097205858 contains a rod with a first connecting portion, a second connecting portion, and a coupling portion for coupling the first connecting portion and the second connecting portion. The first connecting portion is fitted on a workpiece, the second connecting portion is fitted on a torque tool. The coupling portion has at least one flat surface formed thereon, at least one sensing element disposed on the rod so as to sense a torque forced by a user and to output a signal, and a display unit electrically connecting with the at least one sensing element so as to display a toque value transformed from the signal outputted by the at least one sensing element.

Nevertheless, a torsion strain gage is fixed on the solid rod away from a socket, so its deformation is insufficient to cause an inaccurate torque measured value.

Referring further to FIGS. 6 and 7, a conventional toque socket contains a torsion strain gage 5 mounted on a socket 6 directly so as to shorten a distance between the torsion strain gage 5 and a working end of the torque tool, and the socket 6 is hollow for lowering insufficient deformation of the torsion strain gage 5, thus having a torque value measured.

However, the torsion strain gage 5 is fixed on a thicker wall of the socket 6, so the precision of the torque value has to be increased further.

The present invention has arisen to mitigate and/or obviate the afore-described disadvantages.

### SUMMARY OF THE INVENTION

The primary object of the present invention is to provide a torque socket structure which has highly accurate sensing function, and its torque socket is capable of measuring a torque data forced on a working end of the torque socket structure accurately, sensitively, and linearly.

To obtain the above objective, a torque socket structure provided by the present invention contains: a body and a digital detecting mechanism.

The body includes a connecting hole for connecting with a torque wrench and a driving orifice for driving nuts or screws, wherein the driving orifice communicates with the connecting hole, the body includes a stepped difference formed between the connecting hole and the driving orifice, and a thickness between an outer surface of the body and an inner wall of the connecting hole is greater than a thickness between the outer surface of the body and an inner wall of the driving orifice.

The digital detecting mechanism includes a torsion strain gage, a processing unit, and a display unit, the torsion strain gage is fixed on a predetermined section of the outer wall of the body which corresponds to the driving orifice, the processing unit electrically connects with the torsion strain gage so as to receive and calculate torque value detected by the torsion strain gage, the display unit electrically connects with the processing unit so as to display torque value calculated by the processing unit.

The torque socket structure further comprising a housing for covering the body, wherein the torsion strain gage and the processing unit of the digital detecting mechanism are mounted in the housing, and the display unit is retained on an outer surface of the housing.

Thereby, since the thickness between the outer surface of the body and the inner wall of the driving orifice is less than the thickness between the outer surface of the body and the inner wall of the connecting hole, and the torsion strain gage is fixed on the outer wall of the body which corresponds to the driving orifice so as to be close to the working end of the body, the torsion strain gage obtains stable deformation, thus increasing precision of the torque value measured.

Furthermore, the torsion strain gage is fixed on the outer wall of the body which corresponds to the driving orifice, a forcing direction will not pass through step mismatch so as to achieve stable deformation and precise measurement.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view showing the exploded components of a torque socket structure according to the present invention.

FIG. 2 is a perspective view showing the assembly of the torque socket structure according to the present invention.

FIG. 3 is a cross sectional view showing the assembly of the torque socket structure according to the present invention.

FIG. 4 is a perspective view showing the application of the torque socket structure according to the present invention.

FIG. 5 is a chart showing the torque data measured from the torque socket structure of the present invention and a conventional torque socket.

FIG. 6 is a perspective view of a conventional torque socket.

FIG. 7 is a cross sectional view of the conventional torque socket.

### DETAILED DESCRIPTION OF THE PREFERRED EMBODIMENTS

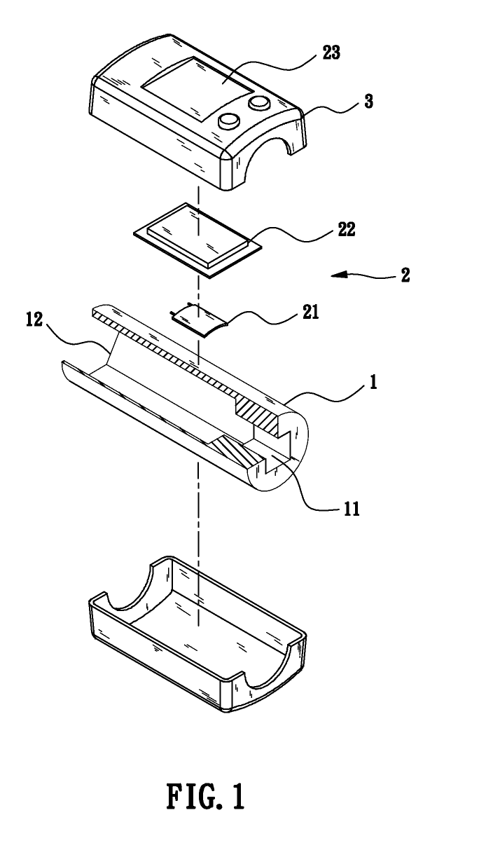

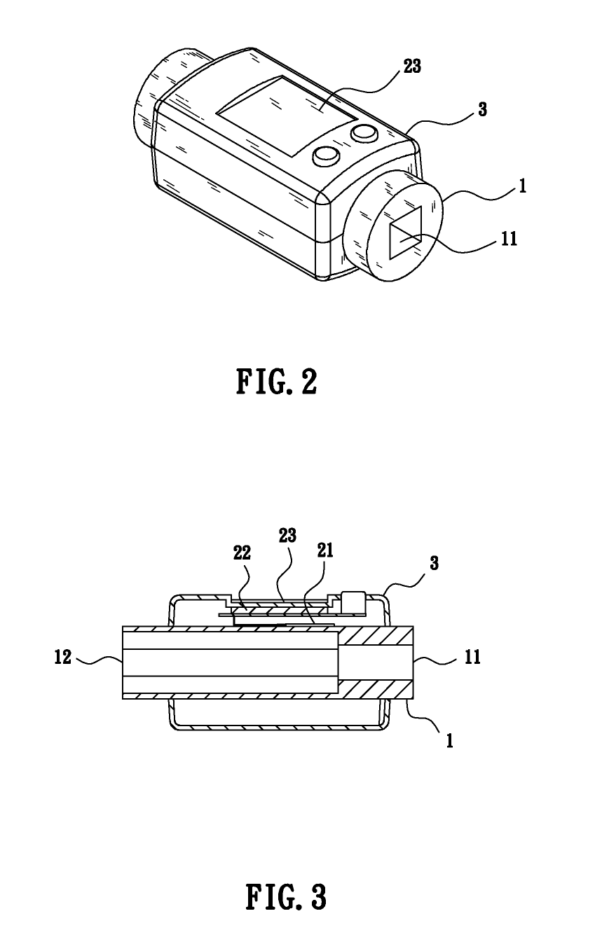

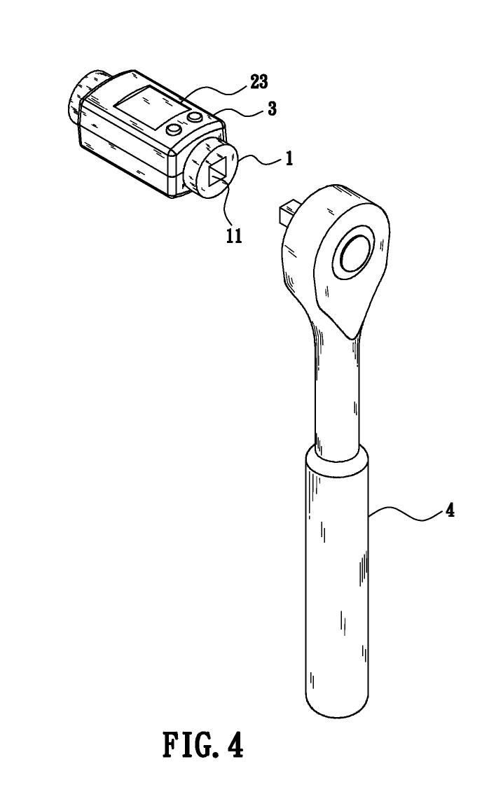

The present invention relates to a torque socket structure which has highly accurate sensing function, and its torque socket is capable of measuring a torque data forced on a working end of the torque socket structure accurately, sensitively, and linearly. With reference to FIGS. 1-5, a torque socket structure of the present invention comprises a body 1 and a digital detecting mechanism 2.

The body 1 includes a connecting hole 11 for connecting with a torque wrench 4 and a driving orifice 12 for driving nuts or screws, wherein the driving orifice 12 communicates with the connecting hole. The body 1 includes a stepped difference formed between the connecting hole 11 and the driving orifice 12, and a thickness between an outer surface of the body 1 and an inner wall of the connecting hole 11 is greater than a thickness between the outer surface of the body 1 and an inner wall of the driving orifice 12.

The digital detecting mechanism 2 includes a torsion strain gage 21, a processing unit 22, and a display unit 23. The torsion strain gage 21 is fixed on a predetermined section of the outer wall of the body 1 which corresponds to the driving orifice 12. The processing unit 22 electrically connects with the torsion strain gage 21 so as to receive and calculate torque value detected by the torsion strain gage 21. The display unit 23 electrically connects with the processing unit 22 so as to display torque value calculated by the processing unit 22.

Thereby, an operator is capable of acquiring the torque value sensed in the driving orifice 12 of the body 1 by ways of the display unit 23. Moreover, the torsion strain gage 21 is fixed on the outer wall of the body 1 which corresponds to the driving orifice 12 so as to be close to the working end of the body 1, hence the torsion strain gage 21 obtains stable deformation so as to increase precision of torque value measured.

The torque socket structure also comprises a housing 3 for covering the body 1, wherein the torsion strain gage 21 and the processing unit 22 of the digital detecting mechanism 2 are mounted in the housing 3, and the display unit 23 is retained on an outer surface of the housing 3.

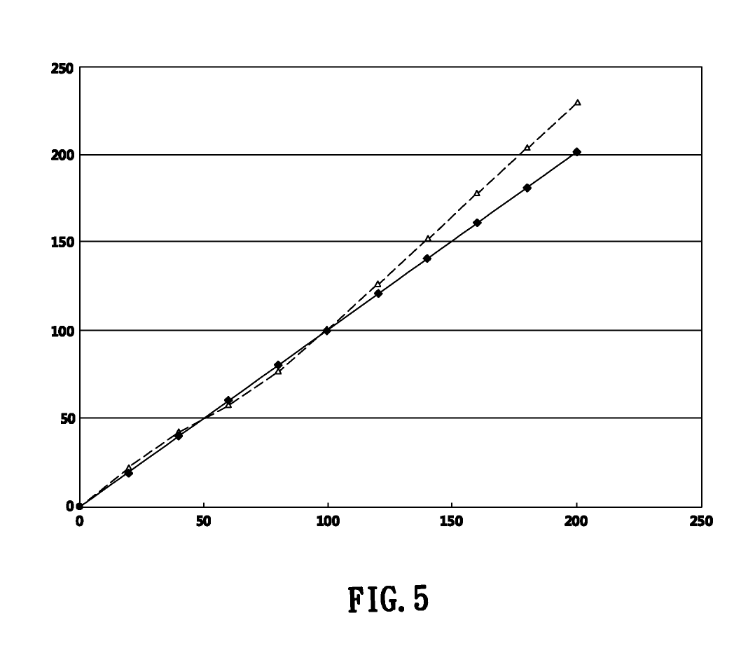

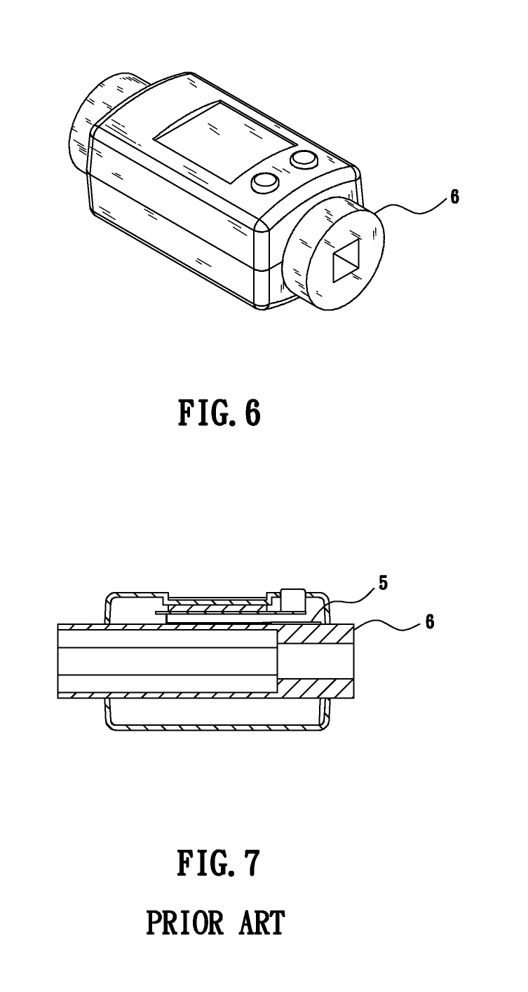

FIG. 5 shows torque values measured from the torque socket structure of the present invention and a conventional torque socket (as illustrated in FIGS. 6 and 7), it further shows difference between sensed value and actually forced torque value, i.e., X axis represents torque values generate when a wrench forces on a torque socket, and Y axis denotes torque values which are sensed. Likewise, black diamond punctuations represent data measured by the torque socket structure of the present invention, and white triangle punctuations denote data measured by the conventional torque socket. Thereby, the torque values, forced by and sensed from the torque socket structure of the present invention, grow linearly. Yet the torque values, forced by and sensed from the conventional torque socket, do not grow linearly. As forcing less than 100 N.m of torque value, the torque values sensed from the conventional torque socket change irregularly. In addition, as forcing more than 100 N.m of torque value, the torque values sensed from the conventional torque socket change more irregularly. However, the torque values sensed from the torque socket structure of the present invention are stable and accurate.

Thereby, since the thickness between the outer surface of the body 1 and the inner wall of the driving orifice 12 is less than the thickness between the outer surface of the body 1 and the inner wall of the connecting hole 11, and the torsion strain gage 21 is fixed on the outer wall of the body 1 which corresponds to the driving orifice 12 so as to be close to the working end of the body 1, the torsion strain gage 21 obtains stable deformation, thus increasing precision of the torque value measured.

Furthermore, the torsion strain gage 21 is fixed on the outer wall of the body 1 which corresponds to the driving orifice 12, a forcing direction will not pass through step mismatch as shown in FIG. 5 so as to achieve stable deformation and precise measurement.

While the preferred embodiments of the invention have been set forth for the purpose of disclosure, modifications of the disclosed embodiments of the invention as well as other embodiments thereof may occur to those skilled in the art.

Accordingly, the appended claims are intended to cover all embodiments which do not depart from the spirit and scope of the invention.

What is claimed is:

1. A torque socket structure comprising: a body and a digital detecting mechanism; wherein
the body includes a connecting hole for connecting with a torque wrench and a driving orifice for driving nuts or screws, wherein the driving orifice communicates with the connecting hole, the body includes a stepped difference formed between the connecting hole and the driving orifice, and a thickness between an outer surface of the body and an inner wall of the connecting hole is greater than a thickness between the outer surface of the body and an inner wall of the driving orifice;
the digital detecting mechanism includes a torsion strain gage, a processing unit, and a display unit, the torsion strain gage is fixed on a predetermined section of the outer wall of the body which corresponds to the driving orifice, the processing unit electrically connects with the torsion strain gage so as to receive and calculate torque value detected by the torsion strain gage, the display unit electrically connects with the processing unit so as to display torque value calculated by the processing unit.

2. The torque socket structure as claimed in claim 1 further comprising a housing for covering the body, wherein the torsion strain gage and the processing unit of the digital detecting mechanism are mounted in the housing, and the display unit is retained on an outer surface of the housing.
